(19) United States
(12) Patent Application Publication
(10) Pub. No.: US 2017/0028423 A1
(43) Pub. Date: Feb. 2, 2017

(54) SHIELD APPARATUS FOR A BLOWGUN

(71) Applicant: Caterpillar Inc., Peoria, IL (US)

(72) Inventors: Jordan B. Sharp, Fargo, ND (US); Charles A. Lindberg, Fargo, ND (US)

(73) Assignee: Caterpillar Inc., Peoria, IL (US)

(21) Appl. No.: 15/291,930

(22) Filed: Oct. 12, 2016

(51) Int. Cl. B05B 15/00; B08B 5/02

(52) U.S. Cl. CPC B05B 15/001; B08B 5/02; B05B 1/005

(57) ABSTRACT

A shield apparatus for a blowgun is provided. The shield apparatus includes a dome portion and a lip portion. The dome portion defines a central axis. The dome portion includes an inner raised section, an outer peripheral section, and an intermediate section extending between the inner raised section and the outer peripheral section. The inner raised section defines a hole along the central axis. The lip portion extends from the outer peripheral section of the dome portion in a direction of the central axis. A portion of a blowpipe of the blowgun is inserted through the hole of the dome portion for mounting the shield apparatus on the blowgun.

### TECHNICAL FIELD

The present disclosure relates to a blowgun. More particularly, the present disclosure relates to a shield apparatus for the blowgun.

### BACKGROUND

During various machining processes, debris is left disposed within some portions of a work piece. For example, during a counterbore drilling process, some debris is left disposed within a counterbore of the work piece. A blowgun is generally employed to clear the debris from such portions of the work piece. The blowgun includes a blowpipe and a nozzle. The nozzle directs a jet of compressed air towards the counterbore of the work piece. The air jet blows out the debris from the counterbore of the work piece. During such operations, the debris is scattered in different directions. Such scattering may cause the debris to be directed towards an operator, resulting in discomfort to the operator during cleaning process. In order to avoid such scattering, a shield apparatus is generally attached to a periphery of the blowpipe of the blowgun.

Conventionally, the shield apparatus is a dome shaped structure that surrounds a portion of the blowpipe of the blowgun. Although, the shield apparatus blocks a part of the debris and prevents scattering of the debris, some part of the debris may still flow towards the operator. This may still result in operator discomfort to perform the cleaning operation. Hence, there exists a need for an improved and efficient shield apparatus for the blowgun.

### SUMMARY OF THE DISCLOSURE

Various aspects of the present disclosure are directed towards a shield apparatus for a blowgun. The shield apparatus includes a dome portion and a lip portion. The dome portion defines a central axis. The dome portion includes an inner raised section, an outer peripheral section, and an intermediate section. The intermediate section extends between the inner raised section and the outer peripheral section. The inner raised section defines the hole along the central axis. The lip portion extends from the outer peripheral section of the dome portion, along a direction of the central axis. A portion of a blowpipe of the blowgun is inserted through the hole of the dome portion for mounting the shield apparatus on the blowgun.

### BRIEF DESCRIPTION OF THE DRAWINGS

FIG. 1 is a perspective view of a blowgun with a shield apparatus, in accordance with the concepts of the present disclosure;

FIG. 2 is a side view of a portion of the blowgun of FIG. 1, illustrating the shield apparatus, in accordance with the concepts of the present disclosure; and

FIG. 3 is a perspective view of the portion of the blowgun of FIG. 1, illustrating the shield apparatus, in accordance with the concepts of the present disclosure.

### DETAILED DESCRIPTION

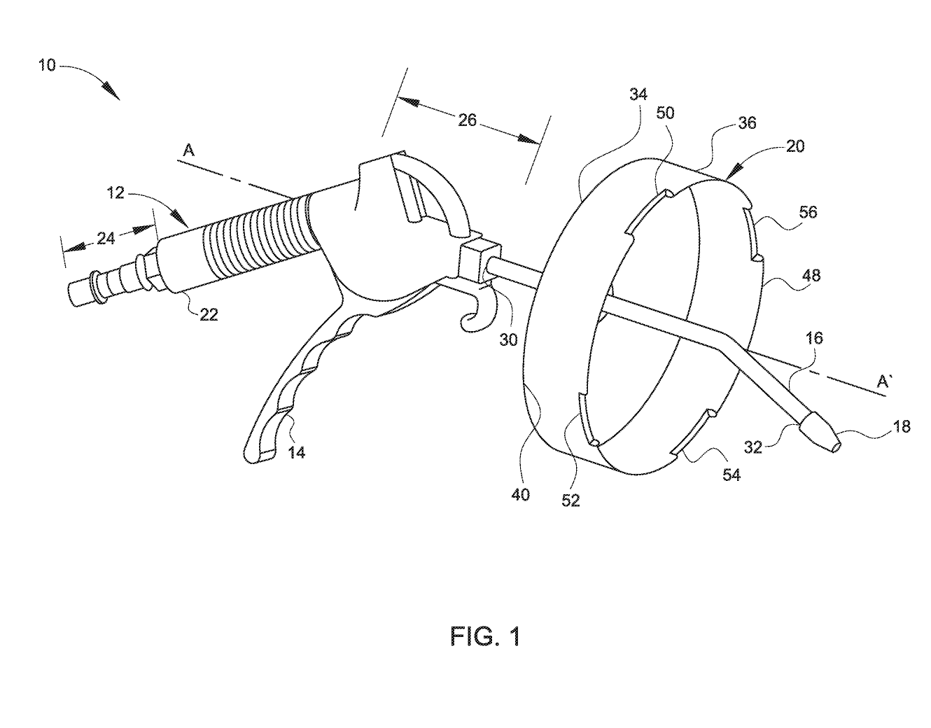

Referring to FIG. 1, there is shown a blowgun 10. The blowgun 10 is employed to supply a jet of compressed air, which is used to clear debris from one or more sections of a work piece (not shown). For example, the blowgun 10 is employed to supply the jet of compressed air, to clear the debris from a counterbore of the work piece (not shown). The blowgun 10 includes a barrel 12, a lever 14, a blowpipe 16, a nozzle 18, and a shield apparatus 20. Examples of the blowgun 10 include, but are not limited to, a straight tip blowgun, an angled tipped blowgun, and a Hi-Booster blowgun.

The barrel 12 defines a grip surface 22, which provides a holding means for the blowgun 10. Further, the barrel 12 includes a first end portion 24, a second end portion 26, and a flow channel (not shown) extending between the first end portion 24 and the second end portion 26. The first end portion 24 is in fluid communication with a compressed air source (not shown). The barrel 12 receives compressed air from the compressed air source (not shown), at the first end portion 24 of the barrel 12. The barrel 12 supplies the compressed air to the blowpipe 16, at the second end portion 26 of the barrel 12.

The lever 14 is coupled at the second end portion 26 of the barrel 12. The lever 14 regulates a flow of the compressed air through the second end portion 26 of the barrel 12. More specifically, in a pressed position, the lever 14 allows flow of the compressed air through the second end portion 26 of the barrel 12 to the blowpipe 16. Additionally, in a released position, the lever 14 restricts the flow of the compressed air through the second end portion 26 of the barrel 12.

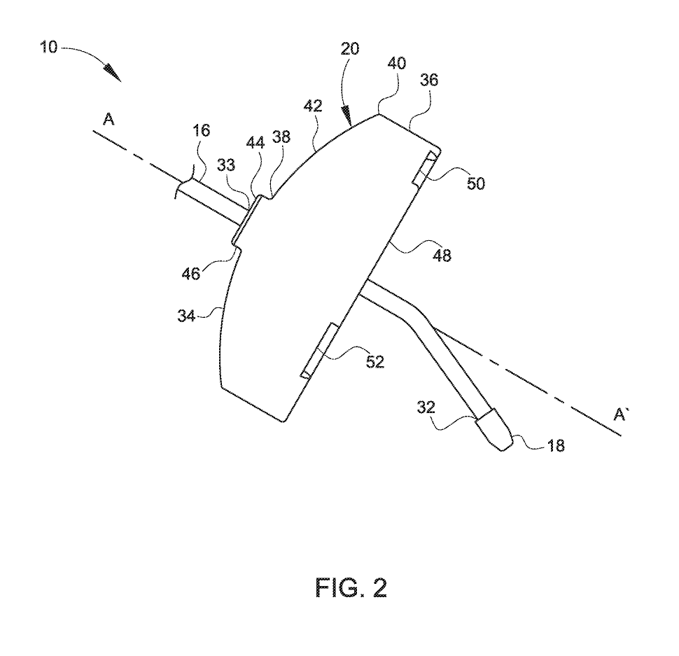

The blowpipe 16 is an elongated tube that includes a barrel-facing end 30, a nozzle-facing end 32, and a shield-mounting portion 33 (as shown in FIG. 2). The shield-mounting portion 33 (as shown in FIG. 2) is defined along a periphery of the blowpipe 16. The barrel-facing end 30 of the blowpipe 16 is installed on the second end portion 26 of the barrel 12, such that the blowpipe 16 is in fluid communication with the barrel 12. The blowpipe 16 receives the compressed air from the barrel 12, at the barrel-facing end 30 of the blowpipe 16. Moreover, the blowpipe 16 supplies the compressed air to the nozzle 18, at the nozzle-facing end 32 of the blowpipe 16.

The nozzle 18 is installed on the nozzle-facing end 32 of the blowpipe 16, such that the blowpipe 16 is in fluid communication with the nozzle 18. The nozzle 18 receives the compressed air from the blowpipe 16. The nozzle 18 increases a kinetic energy of the received compressed air and ejects a jet of compressed air. Examples of the nozzle 18 include, but are not limited to, a venturi nozzle, a flat nozzle, a convergent nozzle, and a convergent-divergent nozzle.

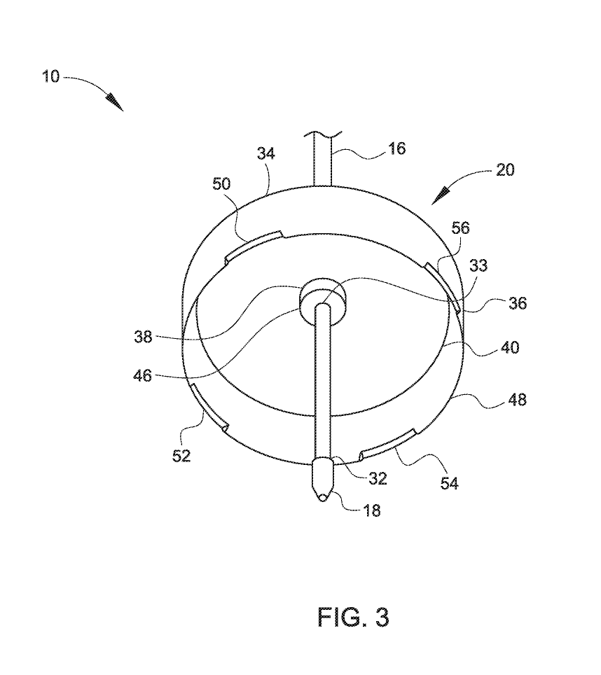

Referring to FIG. 2 and FIG. 3, the shield apparatus 20 is shown. The shield apparatus 20 is attached to the shield-mounting portion 33 of the blowpipe 16. The shield apparatus 20 forms a canopy structure above the nozzle 18 of the blowgun 10. The shield apparatus 20 includes a dome portion 34 and a lip portion 36.

The dome portion 34 of the shield apparatus 20 is an inverted hollow semi-spherical structure that defines a central axis A-A′. The dome portion 34 includes an inner raised section 38, an outer peripheral section 40, and an intermediate section 42. The inner raised section 38 defines a hole 44 along the central axis A-A′. The outer peripheral section 40 is defined along an external periphery of the dome portion 34. The intermediate section 42 is a curved section disposed between the inner raised section 38 and the outer peripheral section 40.

In an embodiment, a hollow cylinder 46 (as shown in FIG. 3) is installed through the inner raised section 38 of the dome portion 34. The hollow cylinder 46 (as shown in FIG. 3) is disposed coaxial to the hole 44 of the inner raised section 38. A portion of the blowpipe 16 is inserted through the hole 44 and the hollow cylinder 46 (as shown in FIG. 3), such that the shield apparatus 20 is installed on the shield-mounting portion 33 of the blowpipe 16.

The lip portion 36 is integrally attached to the outer peripheral section 40 of the dome portion 34. The lip portion 36 extends from the outer peripheral section 40, along a direction of the central axis A-A′. The lip portion 36 includes an outer circumference 48. The outer circumference 48 defines four notches 50, 52, 54, and 56. The notches 50, 52, 54 and 56 are spaced apart such that, a first notch 50 is located diagonally opposite to a third notch 54 and a second notch 52 is located diagonally opposite to a fourth notch 56. Although, in the present disclosure, the outer circumference 48 defines four notches 50, 52, 54, and 56, however, in an embodiment, the outer circumference 48 may define any number of notches, which may be spaced in any configuration. Further, in the present disclosure, the dome portion 34 and the lip portion 36 are described as an integrally casted component, however, it may be contemplated that the dome portion 34 and the lip portion 36 may be individual components suitably attached with each other.

### INDUSTRIAL APPLICABILITY

In operation, the blowgun 10 is employed to blow off the debris from one or more sections of the work piece (not shown). For example, the blowgun 10 is employed to blow off the debris from the counterbore of the work piece (not shown). In order to remove the debris, the nozzle 18 of the blowgun 10 directs the jet of compressed air towards the counterbore of the work piece (not shown). The jet of compressed air blows off the debris from the counterbore. Due to the jet of compressed air, the debris flows in a direction opposite to the nozzle 18. The shield apparatus 20 is mounted at the shield-mounting portion 33 of the blowpipe 16, such that the shield apparatus 20 blocks the debris flowing away from the nozzle 18. A process of prevention of scattering of the debris will be discussed in details hereinafter.

Upon application of the jet of compressed air by the blowgun 10, the debris flows towards the dome portion 34 of the shield apparatus 20. The dome portion 34 creates a barrier for the approaching debris and directs the debris towards the lip portion 36. The lip portion 36 extends along the direction of the central axis A-A′ from the outer peripheral section 40 of the dome portion 34, such that the lip portion 36 blocks scattering of the debris, and directs the debris along the direction of the central axis A-A′. More specifically, an extended boundary defined by the lip portion 36 creates a covered space around the counterbore. The covered space confines movement of the debris and the extended boundary defines the direction of flow of the debris. During the operation, the notches 50, 52, 54, and 56 defines an outlet for air, in order to release pressure under the shield apparatus 20.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claims and any equivalents thereof.

What is claimed is:

1. A shield apparatus for a blowgun, the shield apparatus comprising:
a dome portion defining a central axis, the dome portion including an inner raised section, an outer peripheral section, and an intermediate section extending between the inner raised section and the outer peripheral section, the inner raised section defining a hole along the central axis; and
a lip portion extending from the outer peripheral section of the dome portion, along a direction of the central axis;
wherein at least a portion of a blowpipe of the blowgun is inserted through the hole of the dome portion for mounting the shield apparatus on the blowgun.
